(19) United States
(12) Patent Application Publication
(10) Pub. No.: US 2016/0041434 A1
(43) Pub. Date: Feb. 11, 2016

(54) PIXEL STRUCTURE AND PIXEL COMPENSATION METHOD THEREOF

(71) Applicants: Shanghai AVIC Optoelectronics Co., Ltd., Shanghai (CN); Tianma Micro-Electronics Co., Ltd., Shenzhen (CN)

(72) Inventors: Feng QIN, Shanghai (CN); Shoufu JIAN, Shanghai (CN); Zhiqiang XIA, Shanghai (CN); Jiongliang FU, Shanghai (CN)

(21) Appl. No.: 14/537,831

(22) Filed: Nov. 10, 2014

(30) Foreign Application Priority Data
Aug. 5, 2014 (CN) 201410380421.1

(51) Int. Cl. G02F 1/1343; G09G 3/36

(52) U.S. Cl. CPC G02F 1/134309; G09G 3/3607; G02F 2001/134345; G09G 2300/0452

(57) ABSTRACT

A pixel structure is disclosed. The pixel structure includes an array of pixels, where each of the pixels includes one or two sub-pixels. Each sub-pixel is one of first, second, and third different colors, and the array includes a first pixel and a plurality of surrounding pixels adjacent to the first pixel. The first pixel includes the same number of sub-pixels as the surrounding pixels, and a sub-pixel configuration of at least one of the surrounding pixels is different from that of the first pixel. A sub-pixel in one of the surrounding pixels adjacent to the first pixel and different from all sub-pixels of the first pixel is a compensation sub-pixel for the first pixel, and at least one of the compensation sub-pixels is used with the first pixel.

### CROSS-REFERENCES TO RELATED APPLICATIONS

This application claims the benefit of priority to Chinese Patent Application No. 201410380421.1, filed with the Chinese Patent Office on Aug. 5, 2014 and entitled “PIXEL STRUCTURE AND PIXEL COMPENSATION METHOD THEREOF”, the content of which is incorporated herein by reference in its entirety.

### BACKGROUND

In the prior art, a white light is consisted of a continuous spectrum ranging from red to purple, whereas three colors of red, green and blue, i.e., RGB, are mixed in equal visual brightness into a white light ray in the computer graphics.

A display panel is consisted of a large number of pixels, and in order for each separate pixel to be capable of displaying in different colors, it needs to be decomposed into three red, green and blue sub-pixels 102 smaller than the pixel 101 in a pixel structure as illustrated in FIG. 1. Stated otherwise, the three sub-pixels are integrated into a color pixel. The three sub-pixels 102 emit light at different brightness, when the pixel 101 needs to display in different colors, resulting visually in a desirable color due to the small size of the sub-pixels 102.

The existing display panel is provided with the pixels by equally dividing each of the pixels into three sub-pixels given in respective different colors resulting in a color pixel. This also has been a sub-pixel arrangement solution common to the majority of liquid crystal displays, and of course the three sub-pixels may be arranged in any order.

However the number of Pixels Per Inch (PPI) will be higher and higher along with better picture display required for a display panel so that the transmissivity of the display panel will be greatly lowered. Moreover there will be larger numbers of data lines and scan lines required for the display panel with a high number of pixels per inch thus resulting in a higher cost.

### SUMMARY

One inventive aspect is a pixel structure. The pixel structure includes an array of pixels, where each of the pixels includes one or two sub-pixels. Each sub-pixel is one of first, second, and third different colors, and the array includes a first pixel and a plurality of surrounding pixels adjacent to the first pixel. The first pixel includes the same number of sub-pixels as the surrounding pixels, and a sub-pixel configuration of at least one of the surrounding pixels is different from that of the first pixel. A sub-pixel in one of the surrounding pixels adjacent to the first pixel and different from all sub-pixels of the first pixel is a compensation sub-pixel for the first pixel, and at least one of the compensation sub-pixels is used with the first pixel.

Another inventive aspect is a method of compensating a first pixel of a display panel including a pixel structure. The pixel structure includes an array of pixels, where each of the pixels includes one or two sub-pixels. Each sub-pixel is one of first, second, and third different colors, and the array includes a first pixel and a plurality of surrounding pixels adjacent to the first pixel. The first pixel includes the same number of sub-pixels as the surrounding pixels, and a sub-pixel configuration of at least one of the surrounding pixels is different from that of the first pixel. A sub-pixel in one of the surrounding pixels adjacent to the first pixel and different from all sub-pixels of the first pixel is a compensation sub-pixel for the first pixel, and at least one of the compensation sub-pixels is used with the first pixel. The method includes using at least one of the compensation sub-pixels with the first pixel, compensating the first pixel with the at least one compensation sub-pixel to display the color of the first sub-pixel, compensating the first pixel with the at least one compensation sub-pixel to display in the color of the second sub-pixel, and compensating the first pixel with the at least one compensation sub-pixel to display in the color of the third sub-pixel.

### BRIEF DESCRIPTION OF THE DRAWINGS

FIG. 1 illustrates a schematic structural diagram of a pixel structure in the prior art;

FIG. 2 illustrates a schematic structural diagram of a pixel structure of an embodiment of the application;

FIG. 3 illustrates a schematic structural diagram of another pixel structure of an embodiment of the application; and

FIG. 4 illustrates a schematic structural diagram of a pixel structure of another embodiment of the application.

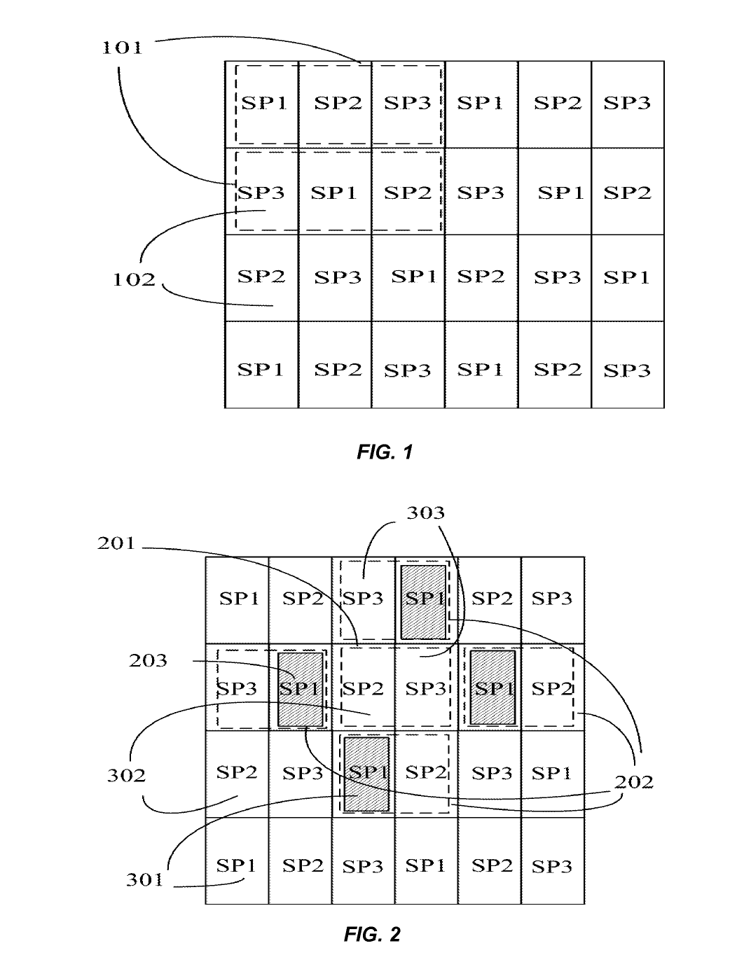

### DETAILED DESCRIPTION OF THE EMBODIMENTS

In order to make the object and features of the application more apparent, particular embodiments of the application will be further described below, but the application can be embodied in different forms and shall not be construed as being limited to the embodiments described below.

There is a pixel structure of an embodiment of the application as illustrated in FIG. 2, where the pixel structure according to the present embodiment includes an array of pixels arranged linearly in both the row direction and the column direction. The pixels each include two sub-pixels among a first sub-pixel 301, a second sub-pixel 302 and a third sub-pixel 303 in different colors. The first sub-pixel, the second sub-pixel and the third sub-pixel as referred to in the application are, respectively, a red sub-pixel, a green sub-pixel and a blue sub-pixel arranged in a varying order. The array includes a first pixel 201 and surrounding pixels 202 adjacent to the first pixel 201. Both the first pixel 201 and each of the surrounding pixels 202 include two sub-pixels, and a sub-pixel configuration of at least one of the surrounding pixels 202 is different from that of the first pixel 201. In the pixel structure illustrated in FIG. 2, all the four surrounding pixels 202 adjacent to the first pixel 201 above, below, on the left and right to the first pixel 201 have sub-pixels configuration different from that of the first pixel 201 merely by way of an example, but in the present embodiment, a part of the surrounding pixels 202 can alternatively have the same sub-pixel configuration as that of the first pixel 201 while the remaining surrounding pixels 202 have a sub-pixel configuration different from that of the first pixel 201, where the part refers to a part of the number of pixels.

As illustrated in FIG. 2, the present embodiment is described where the first pixel 201 does not include the first sub-pixel 301 merely by way of an example, but the present embodiment can alternatively relate to the first pixel 201 which does not include the second sub-pixel 302 or the third sub-pixel 303, but the later will not be described here due to their implementations varying without departing from the same principle. Referring to FIG. 2, the first pixel 201 includes the second sub-pixel 302 and the third sub-pixel 303, and the surrounding pixel 202 includes the first sub-pixel 301, different from all sub-pixels of the first pixel 201, adjacent to the first pixel 201, where the first sub-pixel 301 is a compensation sub-pixel 203. In the present embodiment, in order to accommodate a varying demand for picture display, all the fourth compensation sub-pixels 203 are used with the first pixel 201 to share brightness of the sub-pixels as illustrated in FIG. 2, or at least one of the compensation sub-pixels 203, e.g., only one or two or three of the compensation sub-pixels 203, are used with the first pixel 201, in the present embodiment.

The present embodiment further provides a pixel compensation method including providing at least one of the compensation sub-pixels for use with the first pixel, where;

S201: the first pixel is compensated with the at least one compensation sub-pixel to display in the color of the first sub-pixel;

S202: the first pixel is compensated with the at least one compensation sub-pixel to display in the color of the second sub-pixel; and

S203: the first pixel is compensated with the at least one of the compensation sub-pixels to display in the color of the third sub-pixel.

In order for better linearity in grayscale, the total luminescent brightness of the compensation sub-pixels 203 is the same as the luminescent brightness of one sub-pixel in the first pixel 201, and the luminescent brightness of two sub-pixels in the first pixel 201 is also the same. The total luminescent brightness is provided by averaging the respective compensation sub-pixels 203 used with the first pixel 201 against the number of the compensation sub-pixels 203. In the pixel structure as illustrated in FIG. 2, all the four compensation sub-pixels 203 are used with the first pixel 201, and the luminescent brightness provided respectively by each of the four compensation sub-pixels 203 is one quarter of the total luminescent brightness. Alike when three of the compensation sub-pixels 203 are used with the first pixel 201, and the luminescent brightness provided respectively by each of the three compensation sub-pixels 203 is one third of the total luminescent brightness, so a description will be omitted below of allocation of the total luminescent brightness when one or two of the compensation sub-pixels 203 are used with the first pixel 201. An effect of consistent uniformity in grayscale can be achieved in picture display and a quality of picture display can be improved due to the same luminescent brightness of the sub-pixels in the first pixel 201 as the total luminescent brightness of the compensation sub-pixels 203.

Also in the present embodiment, if the luminescent brightness of the sub-pixels in the first pixel 201 can not reach the highest luminescent brightness thereof in the event that the sub-pixels in the first pixel 201 are also used with the surrounding pixels 202 as compensation sub-pixels, a part of the luminescent brightness needs to be further provided for use with the surrounding pixels 202. Thus preferably the first pixel 201 is provided with one to two thirds of the highest luminescent brightness of the sub-pixels in the first pixel 201 while the remaining luminescent brightness of the sub-pixels in the first pixel 201 is provided for use with the surrounding pixels 202.

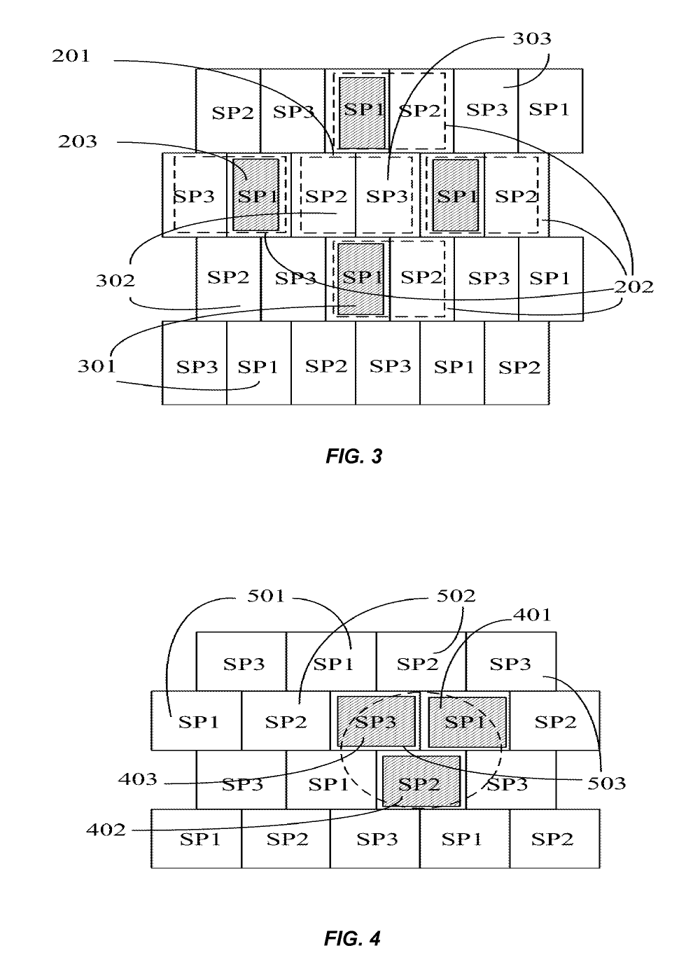

The present embodiment further relates to a variant of the pixel structure as illustrated in FIG. 3, where the array of pixels arranged linearly in the row direction and zigzag in the column direction, and the horizontal spacing between the sub-pixels in adjacent rows is one half of the length of the sub-pixels in the row direction. Alike both the first pixel 201 and each of the surrounding pixels 202 include two sub-pixels, and a sub-pixel configuration of at least one of the surrounding pixels 202 is different from that of the first pixel 201. In the pixel structure illustrated in FIG. 3, all the four surrounding pixels 202 adjacent to the first pixel 201 above, below, on the left and right to the first pixel 201 have a sub-pixels configuration different from that of the first pixel 201 merely by way of an example, but in the present embodiment, a part of the surrounding pixels 202 can alternatively include the same sub-pixels as those of the first pixel 201 while the remaining surrounding pixels 202 have a sub-pixels configuration different from that of the first pixel 201. The pixel structure is described where the first pixel 201 does not include the first sub-pixel 301 adjacent to the first pixel 201 again by way of an example, where the first sub-pixel 301 is a compensation sub-pixel 203. Allocation of the total luminescent brightness of the compensation sub-pixels and compensation of the pixel can be the same as the pixel structure illustrated in FIG. 2.

In another embodiment of the application, a pixel structure as illustrated in FIG. 4 includes an array of pixels including a plurality of pixels arranged linearly in the row direction and zigzag in the column direction, and the horizontal spacing between the sub-pixels in adjacent rows is one half of the length of the sub-pixels in the row direction. The respective pixels includes a first pixel 401 and several surrounding pixels adjacent to the first pixel 401, the surrounding pixels include a second pixel 402 and a third pixel 403, and the first to third pixels each include one sub-pixel and include a first sub-pixel 501, a second sub-pixel 502 and a third sub-pixel 503 respectively, the first sub-pixel 501, the second sub-pixel 502 and the third sub-pixel 503 are different from each other, where the sub-pixels of the first pixel to the third pixel are compensation sub-pixels for each other.

The luminescent brightness of the sub-pixels of the first pixel to the third pixel is the same. Alike if the sub-pixels of the first pixel 401, the second pixel 402 and the third pixel 403 can not reach the highest luminescent brightness thereof in the event that the sub-pixels of the first pixel 401, the second pixel 402 and the third pixel 403 are used with other repeatedly combined adjacent pixels as compensation sub-pixels, then the luminescent brightness of the sub-pixels are preferably one sixth to third of the highest luminescent brightness thereof

The present embodiment further provides a pixel compensation method including: providing the surrounding pixels including the second pixel and the third pixel, where the first to third pixels each include one sub-pixel, and the sub-pixels of the first pixel to the third pixel are different from and function as compensation sub-pixels to each other; and compensated the first pixel with the second and third pixels.

Evidently those skilled in the art can make various modifications and variations to the application without departing from the spirit and scope of the application. Thus the application is also intended to encompass these modifications and variations thereto so long as the modifications and variations come into the scope of the claims appended to the application and their equivalents.

What is claimed:

1. A pixel structure, the structure comprising:
an array of pixels, wherein each of the pixels comprises one or two sub-pixels, wherein each sub-pixel is one of first, second, and third different colors,
wherein the array comprises a first pixel and a plurality of surrounding pixels adjacent to the first pixel, wherein the first pixel comprises the same number of sub-pixels as the surrounding pixels,
wherein a sub-pixel configuration of at least one of the surrounding pixels is different from that of the first pixel,
wherein a sub-pixel in one of the surrounding pixels adjacent to the first pixel, and different from all sub-pixels of the first pixel is a compensation sub-pixel for the first pixel, and
wherein at least one of the compensation sub-pixels is used with the first pixel.

2. The pixel structure of claim 1, wherein the array is arranged linearly in the row direction.

3. The pixel structure of claim 2, wherein the array is arranged linearly in the column direction.

4. The pixel structure of claim 2, wherein the array is arranged zigzag in the column direction, and the horizontal spacing between the sub-pixels in adjacent rows is one half of the length of the sub-pixels in the row direction.

5. The pixel structure of claim 1, wherein the luminescent brightness of one sub-pixel in the first pixel is the same as the total luminescent brightness of the compensation sub-pixels of the first pixel.

6. The pixel structure of claim 5, wherein the total luminescent brightness is provided by averaging the respective compensation sub-pixels used with the first pixel against the number of the compensation sub-pixels.

7. The pixel structure of claim 5, wherein the luminescent brightness of a sub-pixel in the first pixel is two thirds of the highest luminescent brightness thereof.

8. The pixel structure of claim 6, wherein the luminescent brightness of a sub-pixel in the first pixel is two thirds of the highest luminescent brightness thereof.

9. The pixel structure of claim 1, wherein the surrounding pixels each comprise a second pixel and a third pixel, wherein the first, second, and third pixels each comprises one sub-pixel, and the sub-pixels of the first, second, and third pixels are different from and function as compensation sub-pixels for each other.

10. The pixel structure of claim 9, wherein the luminescent brightness of the sub-pixels of the first, second, and third pixels are the same.

11. The pixel structure of claim 1, wherein the first, second, and third sub-pixels are, respectively, a red sub-pixel, a green sub-pixel, and a blue sub-pixel arranged in a varying order.

12. A display panel, comprising a plurality of the pixel structures according to claim 1, where pixel drive circuits are arranged in a matrix.

13. The display panel of claim 12, wherein the surrounding pixels each comprise a second pixel and a third pixel, wherein the first, second, and third pixels each comprise one sub-pixel, and the sub-pixels of the first, second, and third pixels are different from and function as compensation sub-pixels for each other.

14. A method of compensating a first pixel of a display panel comprising a pixel structure, the structure comprising:
an array of pixels, wherein each of the pixels comprises one or two sub-pixels, wherein each sub-pixel is one of first, second, and third different colors,
wherein the array comprises the first pixel and a plurality of surrounding pixels adjacent to the first pixel, wherein the first pixel comprises the same number of sub-pixels as the surrounding pixels,
wherein a sub-pixel configuration of at least one of the surrounding pixels is different from that of the first pixel,
wherein a sub-pixel in one of the surrounding pixels adjacent to the first pixel, and different from all sub-pixels of the first pixel is a compensation sub-pixel for the first pixel, and
wherein at least one of the compensation sub-pixels is used with the first pixel,
wherein the method comprises:
using at least one of the compensation sub-pixels with the first pixel;
compensating the first pixel with the at least one compensation sub-pixel to display the color of the first sub-pixel;
compensating the first pixel with the at least one compensation sub-pixel to display in the color of the second sub-pixel; and
compensating the first pixel with the at least one compensation sub-pixel to display in the color of the third sub-pixel.

15. The method of claim 14, further comprising:
wherein the surrounding pixels comprise a second pixel and a third pixel, wherein the first, second, and third pixels each comprise one sub-pixel, and the sub-pixels of the first, second, and third pixels are different from and function as compensation sub-pixels for each other; and
compensating the first pixel with the second and third pixels.
